(19) United States
(12) Patent Application Publication
(10) Pub. No.: US 2024/0284566 A1
(43) Pub. Date: Aug. 22, 2024

(54) OPERATING METHOD FOR AN ELECTRIC ARC FURNACE

(71) Applicant: Primetals Technologies Germany GmbH, Erlangen (DE)

(72) Inventor: Thomas MATSCHULLAT, Eckental (DE)

(21) Appl. No.: 18/571,710

(22) PCT Filed: Jun. 9, 2022
(86) PCT No.: PCT/EP2022/065633

§ 371 Date: Dec. 18, 2023

(30) Foreign Application Priority Data
Jun. 22, 2021 (EP) 21180899.3

(51) Int. Cl. H05B 7/148; C21C 5/52; F27B 3/08; F27D 19/00; H05B 7/20

(52) U.S. Cl. CPC H05B 7/148; C21C 5/5211; F27B 3/085; F27D 19/00; H05B 7/20; F27D 2019/0037

(57) ABSTRACT

A control device of an electric arc furnace that controls, in a melting phase and subsequently in a flat bath phase, an energy supply device with first control values (A1), such that the energy supply device supplies electrical energy to electrodes of the electric arc furnace via a furnace transformer. The control device, in both phases, further controls a positioning device with second control values (A2), such that said positioning device positions the electrodes relative to the unmolten steel-containing material in the melting phase and relative to the molten steel in the flat bath phase. As a result, electric arcs are formed in both phases, by means of which the steel-containing material is melted or the molten steel is further heated.

### TECHNICAL FIELD

The present invention takes an operating method for an electric arc furnace as a starting point,
a control device of the electric arc furnace, initially in a melting phase and after that in a flat-bath phase that follows the melting phase, activating a power supply device of the electric arc furnace using first activation values, so that the power supply device draws electrical energy from a supply system and supplies it via a furnace transformer to electrodes of the electric arc furnace, and furthermore activating a positioning device of the electric arc furnace using second activation values, so that the positioning device positions the electrodes relative to steel-containing material in solid aggregate state, which is located in a furnace vessel of the electric arc furnace, in the melting phase, so that electric arcs form between the electrodes and the steel-containing material in the melting phase, by means of which the steel-containing material is melted to form a steel melt, and is positioned relative to the steel melt in the flat-bath phase, so that in the flat-bath phase electric arcs form between the electrodes and the steel melt, by means of which the steel melt is heated further,
the control device determining both the first activation values and the second activation values during the melting phase in such a manner that electrical parameters of the electrical energy supplied to the electrodes are approximated as far as possible to corresponding target values,
the control device determining the first activation values in such a manner during the flat-bath phase that the electrical parameters are approximated as far as possible to the corresponding target values.

The present invention furthermore takes a control program for a control device of an electric arc furnace as a starting point, the control program comprising machine code that can be executed by the control device, the execution of the machine code by the control device causing the control device to operate an electric arc furnace according to an operating method of this type.

The present invention furthermore takes a control device of an electric arc furnace as a starting point, the control device being programmed with a control program of this type, so that the control device operates the electric arc furnace according to an operating method of this type.

The present invention furthermore takes an electric arc furnace as a starting point,
the electric arc furnace having a furnace vessel, to which steel-containing material can be supplied in solid aggregate state,
the electric arc furnace having a power supply device and electrodes and also a furnace transformer,
the power supply device being connected at the input side to a supply system and at the output side via the furnace transformer to the electrodes,
the electric arc furnace having a positioning device, by means of which the electrodes can be positioned relative to the steel-containing material in a melting phase and relative to a steel melt, which is created by melting the steel-containing material, in a flat-bath phase that follows the melting phase,
the electric arc furnace having a control device, by which, both in the melting phase and in the flat-bath phase, the power supply device can be activated using first activation values and the positioning device can be activated using second activation values,
the control device being designed as explained above.

### PRIOR ART

The aforementioned subjects are known in general. For example, reference may be made to WO 2015/176 899 A1. EP 1 026 921 A1 and EP 3 124 903 A1 may also be mentioned in this context.

An operating method for an electric arc furnace is also known from WO 2019/207 611 A1. In this operating method, the power supply device is designed for the electrodes of the electric arc furnace as an indirect converter. The indirect converter appears to be downstream of the furnace transformer. WO 2019/207 611 A1 does not cover the position control of the electrodes in more detail.

An operating method for an electric arc furnace is known from EP 3 124 903 A1, in which a power supply device for the electrodes and a positioning device for the electrodes are activated together as a function of electrical operating values of the electric arc furnace.

An operating method for an electric arc furnace during what is known as the melt-down phase is known from U.S. Pat. No. 5,115,447 A, in which the electrodes are inspected individually for short circuit and for breakdown of the electric arc and the electrode position is corrected if such a state occurs.

### SUMMARY OF THE INVENTION

During the melting of steel in an electric arc furnace, the supply of the electrical energy to the electrodes of the electric arc furnace takes place via a furnace transformer. Often, the furnace transformer is connected to the supply system via a medium-voltage transformer. The furnace transformer provides a plurality of voltage steps. For the range of constant power and other high-current ranges, the respective voltage step can be chosen at the furnace transformer. Fine control within a certain voltage step can for example take place by means of impedance control.

In this approach, only a few voltage steps are possible and the electrode currents are subject to strong fluctuations. To reduce the fluctuations, the positioning of the electrodes is controlled mechanically, for the most part by means of hydraulic adjusting devices. The mechanical adjustment of the electrodes has considerably smaller dynamics than the real behavior of the electric arcs. The fluctuations can therefore only be compensated for unsatisfactorily. Furthermore, the fluctuations lead to considerable loads of the components, for example the high current cables, the current-carrying brackets, the hydraulic cylinders, etc. The fluctuations occur both in the melting phase and in the flat-bath phase.

In the flat-bath phase, relatively small voltages are generally applied to the electrodes and the electrodes are furthermore positioned relatively close to the surface of the steel melt. High currents are set as a result. At the same time, heat losses are reliably shielded by means of the foamed slag. Depending on the performance level of the electric arc furnace or during the creation of certain steels (particularly of stainless steels and high-grade steels), the electric arcs are only partially or not at all enveloped by the foamed slag, however. The energy efficiency of the electric arc furnace falls as a result.

During the adjustment of the electrode voltage via the voltage steps of the furnace transformer, the positioning of the electrodes must be continually readjusted. The readjustment can for example take place in such a manner that control is carried out to a certain impedance or a certain power. As the dynamics of the positioning device is relatively low compared to the changes in the electrical system of the electric arc, certain fluctuations remain, which cannot be compensated for. The fluctuations are increased again by wave motions and flows of the steel melt. As a result, the energy input into the steel melt is not optimal.

Approaches are known from the documents of the prior art, particularly from WO 2015/176 899 A1 and EP 3 124 903 A1 and to a limited extent also from EP 1 026 921 A1, in which the electrode voltages can be adjusted continuously. These embodiments offer considerable advantages compared to adjusting the electrode voltage by means of voltage steps of the furnace transformer. On the one hand, the electrode voltages can be varied not only step-by-step, but rather continuously. On the other hand, the furnace transformer can be designed more simply, because it does not have to provide a plurality of voltage steps. Furthermore, further types of control are enabled by these embodiments.

The object of the present invention consists in creating options, by means of which a fast and high-quality control of the electric arcs is possible in the flat-bath phase in a simple and reliable manner.

The object is achieved by an operating method having the features of claim 1. Advantageous embodiments of the operating method are the subject of the dependent claims 2 to 8.

According to the invention, an operating method of the type mentioned in the introduction is configured in that the control device determines the second activation values during the flat-bath phase either completely independently of the electrical parameters or depending on the electrical parameters only if the control device detects the danger of an electric arc breakdown and/or a short circuit on the basis of the electrical parameters.

The first activation values are therefore determined in such a manner by the control device during the flat-bath phase—as also in the prior art—that the electrical parameters are approximated to the corresponding target values as far as possible. By contrast, the second activation values are—except in the event of a danger of particular operating states that must absolutely be avoided—determined independently of the electrical parameters. As a result, the correction of the electrode voltages and the electrode currents therefore takes place exclusively by adapting the activation of the power supply device.

The electrical parameters of the electrical energy that is supplied to the electrodes can be determined as required. For example, the electrical parameters may be the electrode currents. The active currents in particular are possible as electrode currents. In particular cases, the electrical parameters may however also be the reactive currents and/or the apparent currents. Alternatively, the electrical parameters may be the electric powers. The active powers in particular are possible as powers. In particular cases, the electrical parameters may however also be the reactive powers and/or the apparent powers.

The voltages applied to the electrodes and therefore also the currents supplied to the electrodes are generally alternating quantities, that is to say AC voltages and alternating currents. Alternating quantities can be characterized by their amplitude, their frequency and their curve during a period (for example sinusoidal, triangular, saw-tooth, square-wave, etc.). The time curve is preferably sinusoidal.

The amplitude must always be set in a suitable manner. The frequency can be kept constant in some cases. In other cases, it is to be preferred however that the control device determines the first activation values during the flat-bath phase in such a manner that to approximate the electrical parameters to the corresponding target values, a frequency of electrode currents supplied to the electrodes and/or of electrode voltages applied to the electrodes is also varied. This approach offers greater flexibility in the optimization of the operation of the electric arc furnace.

Preferably, the frequency of the electrode currents supplied to the electrodes and/or the electrode voltages applied to the electrodes in the flat-bath phase is smaller than a base frequency of the supply system. This approach has proven particularly advantageous in experiments.

At the start of the flat-bath phase, the electrodes are spaced from the surface of the steel melt. The electric arcs consequently have a basic length at the start of the flat-bath phase. In some situations, it is advantageous that the control device moves the electrodes toward the steel melt during the flat-bath phase, so that after moving toward the steel melt, the electric arcs still have a residual length that is smaller than the basic length. In order to avoid the danger of a short circuit, a certain minimum length should not be fallen below, however. For this reason, the residual length is preferably at least 20% of the basic length.

The basic length can be determined or at least estimated on the basis of the electrical parameters as they are present at the start of the flat-bath phase. It is possible that this determination/estimation takes place intellectually by means of a person. However, it preferably takes place by means of the control device.

The object is furthermore achieved by a control program having the features of claim 9. According to the invention, the execution of the machine code by the control device preferably causes the control device to operate an electric arc furnace according to an operating method according to the invention.

The object is furthermore achieved by a control device having the features of claim 10. According to the invention, the control device is programmed with a control program according to the invention, so that the control device operates the electric arc furnace according to an operating method according to the invention.

The object is furthermore achieved by an electric arc furnace having the features of claim 11. According to the invention, the control device is designed as a control device according to the invention.

### BRIEF DESCRIPTION OF THE DRAWINGS

The above-described properties, features and advantages of this invention and the manner in which these are achieved become clearer and more clearly understandable in connection with the following description of the exemplary embodiments that are explained in more detail in connection with the drawings. In the figures, in schematic illustration:

FIG. 1 shows a block circuit diagram of an electric arc furnace,

FIG. 2 shows a furnace vessel during a melting phase,

FIG. 3 shows a flowchart,

FIG. 4 shows the mode of action of a control device in the melting phase,

FIG. 5 shows the furnace vessel during a flat-bath phase,

FIG. 6 shows the mode of action of the control device in the flat-bath phase,

FIG. 7 shows a modification of FIG. 6,

FIG. 8 shows a flowchart,

FIG. 9 shows a determination block,

FIG. 10 shows a determination block and a trailer block,

FIG. 11 shows a time graph,

FIG. 12 shows a modification of FIG. 5,

FIG. 13 shows a time graph, and

FIG. 14 shows a flowchart.

### DESCRIPTION OF THE EMBODIMENTS

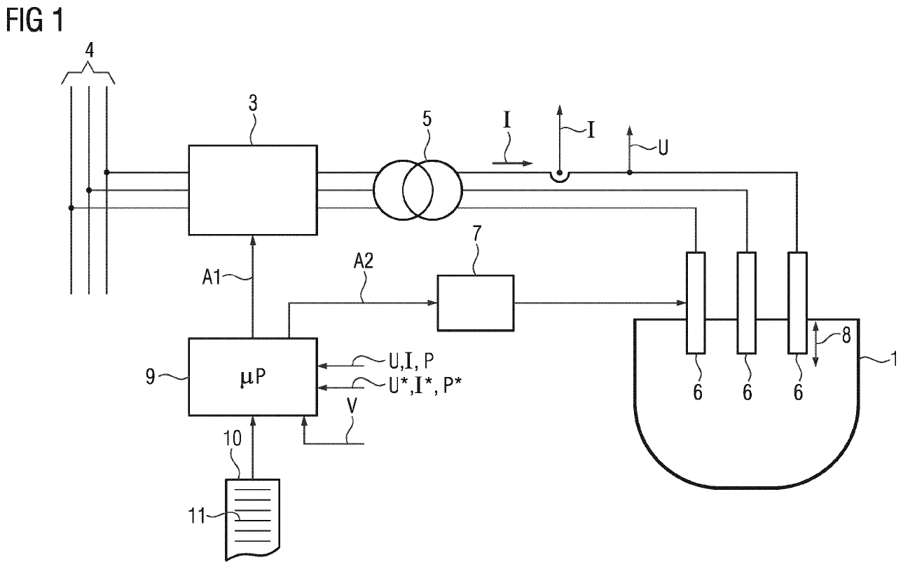

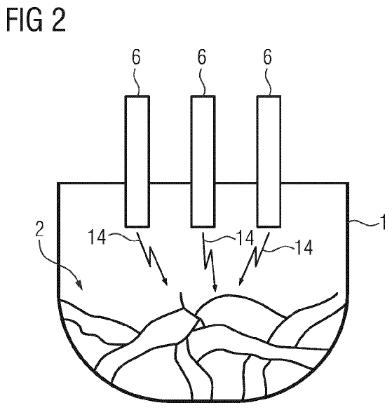

According to FIG. 1, an electric arc furnace has a furnace vessel 1. Steel-containing material 2 can—see FIG. 2—be supplied to the furnace vessel 1. The steel-containing material 2 is supplied to the furnace vessel 1 in solid aggregate state. The steel-containing material 2 may be scrap for example.

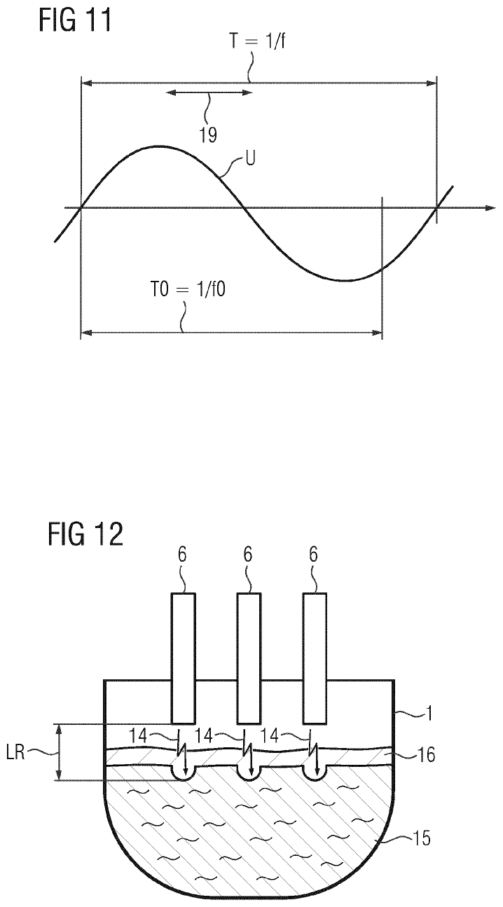

The electric arc furnace furthermore has a power supply device 3. The power supply device 3 is connected at the input side to a supply system 4. The supply system 4 is generally a medium-voltage system, which has a nominal voltage in the 2-digit kV range and is operated with a base frequency f0 (see FIG. 11). The base frequency f0 is generally 50 Hz or 60 Hz. According to the illustration in FIG. 1, the supply system 4 is generally a three-phase system.

The electric arc furnace furthermore has a furnace transformer 5 and electrodes 6. The power supply device 3 is connected at the output side to the electrodes 6 via the furnace transformer 5. Generally, in accordance with the illustration in FIG. 1, a plurality of electrodes 6 are present and the furnace transformer 5 is furthermore designed as a three-phase transformer. However, other embodiments are also possible, particularly a single-phase embodiment. Independently of the actual embodiment, electrode voltages U that are applied to the electrodes 6 are clearly below the nominal voltage of the supply system 4, however. The electrode voltage U is only illustrated for one of the electrodes 6 in FIG. 1. For the most part, the electrode voltages U lie in the range of several 100 V. Voltages above 1 kV are also possible in particular cases. 2 kV is generally not exceeded however.

Generally, switching equipment is furthermore present, by means of which the power supply device 3 can be disconnected from the supply system 4. Furthermore, switching equipment may be present, by means of which the power supply device 3 can be disconnected from the furnace transformer 5 and/or the furnace transformer 5 can be disconnected from the electrodes 6. The switching equipment carries out purely binary switching operations, but no adjustment of voltages and currents. Furthermore, active or passive filter devices may be arranged on the primary side or secondary side of the furnace transformer 5. The switching equipment and also the filter devices are of subordinate importance for the functionality according to the invention and therefore not also illustrated in FIG. 1 (and also the other FIGs) for the sake of clarity.

The power supply device 3 can draw electrical energy from the supply system 4 and supply the electrical energy drawn to the electrodes 6 via the furnace transformer 5. The power supply device 3 generally has many semiconductor switches for this purpose. Possible embodiments of the power supply device 3 are described in WO 2015/176 899 A1 (“gold standard”). Alternatively, the embodiments according to EP 3 124 903 A1 or EP 1 026 921 A1 may for example also be used. Independently of the actual embodiment of the power supply device 3, the power supply device 3 is however able at the output side—that is to say toward the furnace transformer 5—to perform an almost continuous stepping of the electrode voltages U applied to the electrodes 6 and/or the electrode currents I supplied to the electrodes 6. Analogously to the illustration for the electrode voltages U, the electrode current I is likewise only illustrated for one of the electrodes 6 in FIG. 1.

Furthermore, the electric arc furnace has a positioning device 7. By means of the positioning device 7, the electrodes 6 can be positioned as is indicated in FIG. 1 by a double arrow 8 next to one of the electrodes 6. In the simplest case, the electrodes 6 are positioned together. However, an individual positioning of the electrodes 6 can also take place. The movement direction in which the electrodes 6 are positioned can be vertical. Alternatively, the movement direction may also be slightly inclined with respect to the vertical. Even in this case however, the component in the vertical direction is the dominant component of the movement. The positioning device 7 may for example have one or more hydraulic cylinder units.

Finally, the electric arc furnace has a control device 9. (At least) the power supply device 3 and the positioning device 7 are controlled by the control device 9. The control device 9 therefore generates first activation values A1, using which it activates the power supply device 3, and second activation values A2, using which it activates the positioning device 7. The power supply device 3 and the positioning device 7 are operated in accordance with the respective activation values A1, A2.

The control device 9 is designed as a software-programmable control device. This is indicated in FIG. 1 by the information “pP” (for microprocessor-controlled). The mode of action and operation of the control device 9 is therefore determined by a control program 10, using which the control device 9 is programmed. The control program 10 comprises machine code 11 that can be executed by the control device 9. The execution of the machine code 11 by the control device 9 causes the control device 9 to operate the electric arc furnace according to an operating method, as is explained in more detail in the following in connection with the further FIGs.

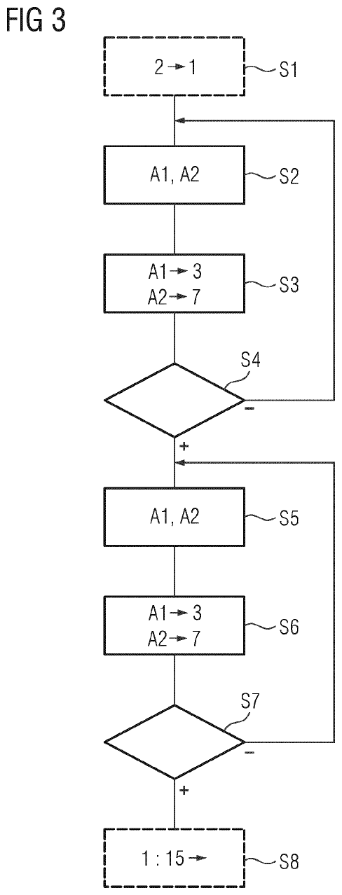

First, the furnace vessel 1 is fed with the steel-containing material 2 according to FIG. 3 in a step S1. This process can, but does not have to, take place under control by the control device 9. The step S1 is therefore only illustrated dashed in FIG. 3.

A melting phase of the electric arc furnace follows the feeding with the steel-containing material 2. The melting phase comprises steps S2 to S4. A flat-bath phase follows the melting phase. The flat-bath phase comprises steps S5 to S7.

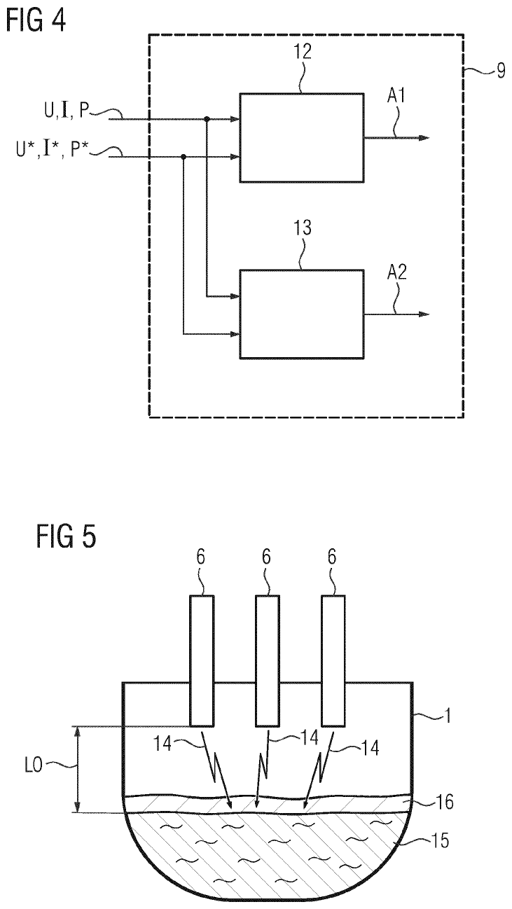

In the melting phase, the control device 9 determines the first activation values A1 for the power supply device 3 and the second activation values A2 for the positioning device 7 in step S2. The determination takes place according to FIG. 4 in corresponding determination blocks 12 and 13. In step S3, the control device 9 activates the power supply device 3 and the positioning device 7 in accordance with the determined activation values A1, A2.

The determination of the first activation values A1 takes place in such a manner that owing to the corresponding activation, the power supply device 3 draws electrical energy from the supply system 4 and supplies it via the furnace transformer 5 to the electrodes 6. The determination of the second activation values A2 takes place in such a manner that the positioning device 7 positions the electrodes 6 relative to the steel-containing material 2. The determination of the first activation values A1 and the determination of the second activation values A2 by the control device 9 are adjusted with respect to one another in such a manner that electric arcs 14 (see FIG. 2) form between the electrodes 6 and the steel-containing material 2. Due to the electric arcs 14, the steel-containing material 2 is melted and thus a steel melt 15 (FIG. 5) is gradually created.

To determine the first activation values A1 and the second activation values A2, parameters U, I, P of the electrical energy supplied to the electrodes 6 are supplied to the control device 9 according to FIG. 4. The parameters U, I, P may for example be the electrode voltages U and/or the electrode currents I and/or values derived therefrom. A derived value is for example the instantaneous power P (=the product of electrode voltage U and electrode current I). A further derived value may result from the time curve of electrode voltages U and electrode currents I. Values of this type are for example the active current, the active power, the apparent power, reactive current and the reactive power. The parameters may alternatively be given or derived for the entirety of the electrodes 6 or individually for the respective electrode 6. To determine the first activation values A1 and the second activation values A2, target values U*, I*, P* for the parameters U, I, P are furthermore supplied to the control device 9, for example target values U*, I* for the electrode voltages U and/or the electrode currents I or other suitable target values (for example a target value P* for the power P). Both the parameters U, I, P and the target values U*, I*, P* are supplied to both determination blocks 12, 13 in the melting phase.

On the basis of the parameters U, I, P and the associated target values U*, I*, P*, the control device 9 determines the first activation values A1 and the second activation values A2. The determination takes place in both determination blocks 12, 13 in such a manner that the electrical parameters U, I, P are approximated as far as possible to the corresponding target values U*, I*, P*. This approach and therefore the implementation of the step S2 is known in general to people skilled in the art. It therefore does not have to be explained in more detail.

In step S4, the control device 9 checks whether the melting phase is complete. The melting phase is complete if the steel melt 15 in accordance with the illustration in FIG. 5 has completely or at least substantially formed a continuous horizontal surface. Therefore, the steel-containing 2 has either melted completely or the not yet melted elements of the steel-containing material 2 are located completely below the surface of the steel melt 15 or the not yet melted elements of the steel-containing material 2 still project beyond the surface of the steel melt 15 only insignificantly. Furthermore, a slag layer 16 may have formed on the surface of the steel melt 15.

It is possible that the control device 9 evaluates actual values of the electric arc furnace that are detected metrologically in the context of the check as to whether the melting phase is complete. For example, it is possible that the control device 9 evaluates the electrode currents I and/or the electrode voltages U, particularly the fluctuations thereof. Also, the control device 9 can evaluate acoustic values of the electric arc furnace, for example the noise level or the acoustic spectrum of the noise generated. Alternatively, it is possible that it is specified for the control device 9 by an operator (not illustrated), that the melting phase is complete.

If the melting phase is not yet complete, the control device 9 then returns to step S2. If by contrast the melting phase is complete, the control device 9 transitions to the flat-bath phase and therefore to the step S5.

In the flat-bath phase, the control device 9 determines the first activation values A1 for the power supply device 3 and the second activation values A2 for the positioning device 7 in step S5. In step S6, the control device 9 activates the power supply device 3 and the positioning device 7 in accordance with the determined activation values A1, A2.

The determination of the first activation values A1 takes place in such a manner that owing to the corresponding activation, the power supply device 3 draws electrical energy from the supply system 4 and supplies it via the furnace transformer 5 to the electrodes 6. The determination of the second activation values A2 takes place in such a manner that the positioning device 7 positions the electrodes 6 relative to the steel melt 15. In this respect, the procedure of steps S5 and S6 matches the procedure of steps S2 and S3.

The procedure of steps S5 and S6 also matches the procedure of steps S2 and S3 to the extent that the first activation values A1 and the second activation values A2 are adjusted with respect to one another in such a manner that electric arcs 14 form. However, the electric arcs 14 form in the flat-bath phase according to the illustration in FIG. 5 between the electrodes 6 and the steel melt 15. The steel melt 15 is heated further due to the electric arcs 14.

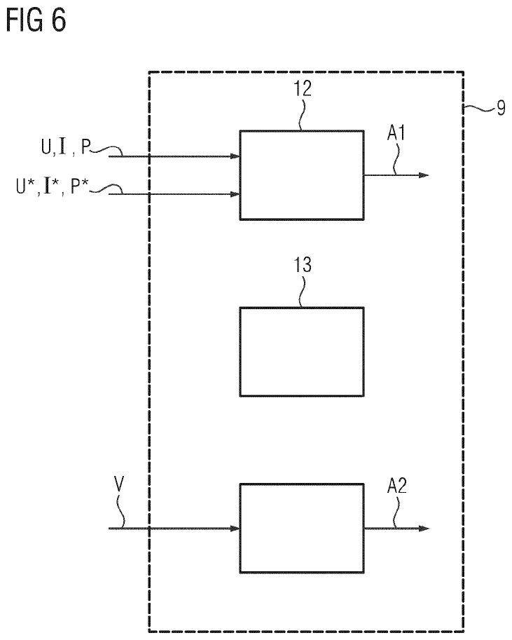

The parameters U, I, P of the electrical energy supplied to the electrodes 6 and the associated target values U*, I*, P* are furthermore also supplied to the control device 6 according to FIG. 6. The parameters U, I, P and the associated target values U*, I*, P* are only supplied to the determination block 12 inside the control device 9, however. Thus, the control device 9 furthermore determines the first activation values A1 in such a manner that the electrical parameters U, I, P are approximated as far as possible to the corresponding target values U*, I*, P*.

By contrast, the determination block 13 is deactivated in the flat-bath phase. Instead, a determination block 17 is activated according to FIG. 6. The control device 9 determines the second activation values A2 by means of the determination block 17 in the flat-bath phase. In particular, it is possible that the control device 9 determines the second activation values A2 completely independently of the electrical parameters U, I, P according to the illustration in FIG. 3. In this case, it is possible that the electrical parameters U, I, P are not at all supplied to the determination block 17 according to the illustration in FIG. 6. Instead, the control device 9 can determine the second activation values A2 on the basis of an otherwise internal determination or on the basis of external specifications V (for example specifications which come from an operator).

In step S7, the control device 9 checks whether the flat-bath phase is complete. It is possible that the control device 9 evaluates actual values of the electric arc furnace that are detected metrologically in the context of the check as to whether the flat-bath phase is complete. Alternatively, it is possible that it is specified for the control device 9 by the operator, that the flat-bath phase is complete.

If the flat-bath phase is not yet complete, the control device 9 returns to step S5. If by contrast the flat-bath phase is complete, the control device 9 transitions to a step S8. In step S8, the steel melt 15 that is created is removed from the furnace vessel 1, for example poured into a ladle (not illustrated). This process can, but does not have to, take place under control by the control device 9. The step S8 is therefore—analogously to step S1—only illustrated dashed in FIG. 3.

With the execution of step S8, a complete cycle in the operation of the electric arc furnace is finished. It is therefore possible to start a new cycle, starting with the step S1.

In the simplest embodiment, the determination of the second activation values takes place, as mentioned previously, independently of the electrical parameters U, I, P.

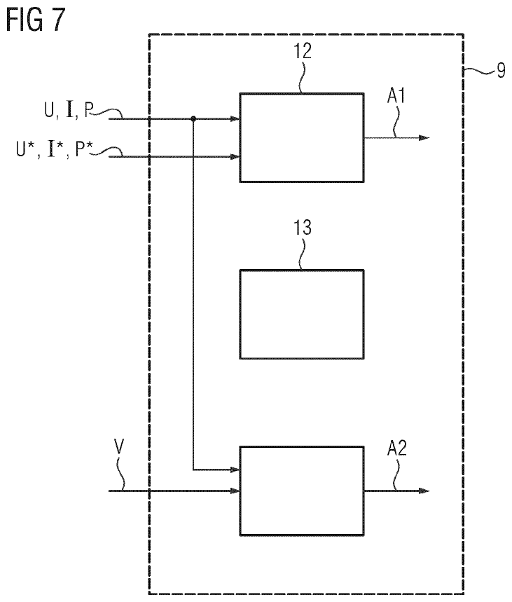

Alternatively, it is possible that although the second activation values A2 are generally determined by the determination block 17 independently of the electrical parameters U, I, P, these are indeed taken into account under certain circumstances. In this case, the corresponding electrical parameters U, I, P are supplied to the determination block 17 according to the illustration in FIG. 7. Also supplying the corresponding target values U*, I*, P* is by contrast not necessary.

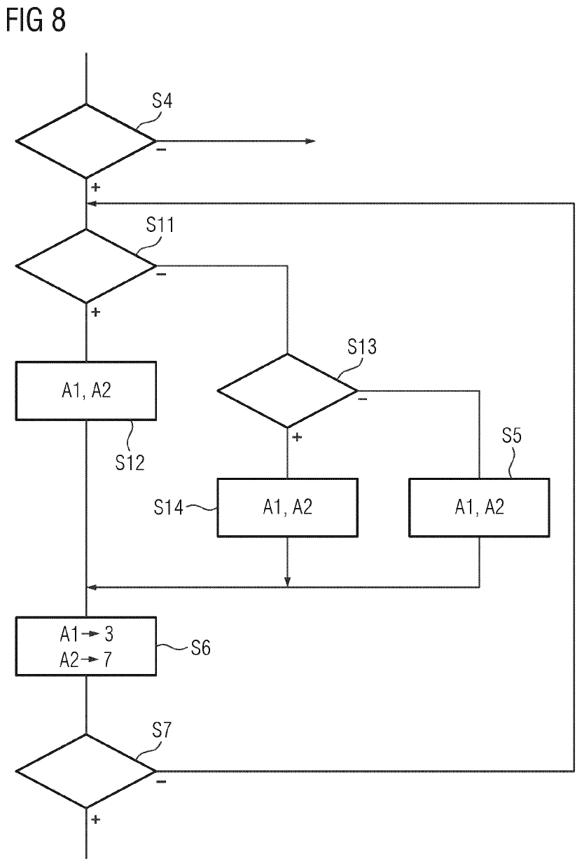

The determination block 17 (and, because the determination block 17 is a constituent of the control device 9, as a result with it the control device 9) in this case checks whether the electrical parameters U, I, P fulfill predetermined conditions or not. In particular, the determination block 17 checks in this case whether it detects the danger of an electric arc breakdown and/or a short circuit on the basis of the electrical parameters U, I, P. Only then does the determination block 17 take the electrical parameters U, I, P into account in the determination of the second activation values A2. In this case also, they are however only taken into account for as long as the danger of an electric arc breakdown and/or a short circuit exists. If the danger no longer exists, the determination of the second activation values A2 also takes place again independently of the electrical parameters U, I, P. This is explained in more detail in the following in connection with FIG. 8.

FIG. 8 shows the procedure in the flat-bath phase. The procedure in the melting phase may be unchanged.

According to FIG. 8, the control device 9 initially transitions from step S4 to a step S11. In step S11, the control device 9 checks whether it detects the danger of an electric arc breakdown. In the context of the checking of step S11, the control device 9 evaluates the electrical parameters U, I, P. If the control device 9 detects the danger of an electric arc breakdown, it transitions to a step S12. In step S12, the control device 9 determines the first activation values A1 and the second activation values A2 such that the danger of the electric arc breakdown is counteracted. For example, the control device 9 can vary the first activation values A1 such that the electrode voltages U are increased and vary the second activation values A2 such that the electrodes 6 are lowered in the direction toward the steel melt 15.

If the control device 9 does not detect the danger of an electric arc breakdown in step S11, the control device 9 transitions to a step S13. In step S13, the control device 9 checks whether it detects the danger of a short circuit. In the context of the checking of step S13, the control device 9 likewise evaluates the electrical parameters U, I, P. If the control device 9 detects the danger of a short circuit, it transitions to a step S14. In step S14, the control device 9 determines the first activation values A1 and the second activation values A2 such that the danger of the short circuit is counteracted. For example, the control device 9 can vary the first activation values A1 such that the electrode voltages U are decreased and in particular vary the second activation values A2 such that the electrodes 6 are lifted in the direction away from the steel melt 15.

If the control device 9 does not detect the danger of a short circuit in step S13, the control device 9 transitions to step S5. In step S5, the determination of the first activation values A1 and the second activation values A2 takes place as was already explained in connection with FIG. 6.

Independently of whether the control device 9 has executed the step S12, the step S14 or the step S5, the control device 9 next transitions to step S6, in which it activates the power supply device 3 and the positioning device 4 in accordance with the determined first and second activation values A1, A2. After that, the control device transitions to step S7. From there, either there is a transition to step S8 or the control device 9 returns to step S11.

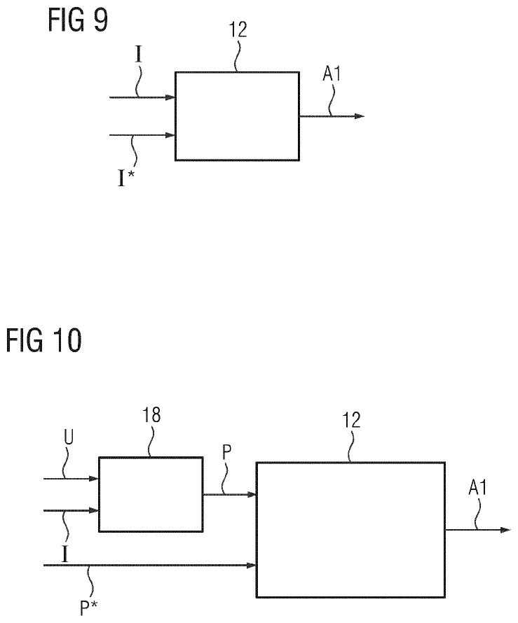

The parameters U, I, P can be chosen in various ways. For example, it is possible according to the illustration in FIG. 9 that—at least during the flat-bath phase—the electrical parameters U, I, P are the electrode currents I. Alternatively, it is possible according to the illustration in FIG. 10 that—at least during the flat-bath phase—the electrical parameters U, I, P are the electric powers P. In this case, a trailer block 18 may for example be upstream of the determination block 12. In this case, the electrode voltages U and the electrode currents I can be supplied to the trailer block 18 for example. The trailer block 18 in this case for example instantaneously determines the instantaneous power or the average electric power over a period of the electrode voltages U and outputs the determined value as electrical parameter P to the determination block 12.

It is possible that the control device 9 determines the first activation values A1 during the flat-bath phase in such a manner that a frequency f of the electrode voltages U (or a frequency f of the electrode currents I, which corresponds with this) is varied. This is indicated in FIG. 11 in that a corresponding period T is varied. The varying of the period T and, corresponding with this, the frequency f is indicated in FIG. 11 by a double arrow 19. It takes place for the purpose of approximating the electrical parameters U, I, P to the corresponding target values U*, I*, P*. The varying of the frequency f preferably takes place in a range that lies between 70% and 90% of the base frequency f0, particularly between 75% and 85% of the base frequency f0.

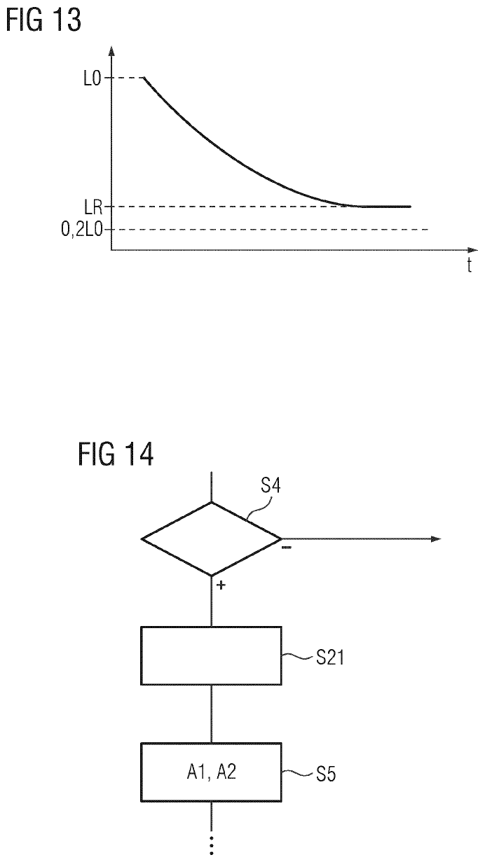

At the start of the flat-bath phase, thus when the control device 9 transitions from step S4 to step S5 (or in the case of the embodiment according to FIG. 8, transitions to step S11), the electric arcs 14 according to the illustration in FIG. 5 have a basic length L0. In some cases, it is advantageous if the control device 9 moves the electrodes 6 toward the steel melt 15 during the flat-bath phase. After moving toward the steel melt 15, the electric arcs 14 according to FIG. 12 only still have a residual length LR. The residual length LR is smaller than the basic length L0. However, according to the illustration in FIG. 13, it should be at least 20% of the basic length L0.

The basic length L0 may become known to the control device 9 in various ways. For example, the basic length L0 of the control device 9 may be specified by the operator. Alternatively, it is possible that, according to the illustration in FIG. 14, the control device 9 initially executes a step S21 directly after the step S4. In this case, the control device 9 determines the basic length L0 in step S21 on the basis of the electrical parameters U, I, P as they are present at the start of the flat-bath phase. Corresponding approaches are known to people skilled in the art. The step S21, if it is present, is only executed once. Therefore, it is not also included in the loop of the steps S5 to S7. This is true analogously if the steps S11 to S14 are present.

It is possible that the control device 9 determines the residual length LR on the basis of the basic length L0. Alternatively, it is possible that the control device 9 determines only one minimum permitted value for the residual length LR or a corresponding minimum permitted value for the residual length LR is predetermined for the control device 9. In this case, it is possible that the control device 9 maintains the movement of the electrodes 6 until the control device 9 detects an optimized operation of the electric arc furnace on the basis of an evaluation of the parameters U, I, P or the residual length RL reaches the minimum permitted value. Independently of the approach actually taken, the step S5 is implemented in such a manner in this case that the first activation values A1 are determined as explained previously, but the second activation values A2 are determined in such a manner that the length of the electric arcs 14 is reduced, starting from the basic length L0. Due to the reduction of the length of the electric arcs 14 to the residual length LR, the energy efficiency of the electric arc furnace can be improved in certain operating states of the electric arc furnace.

The present invention has many advantages. In particular however, the mechanical loading of the positioning device 7 can be reduced and the energy efficiency during operation of the electric arc furnace can furthermore be improved.

Although the invention was illustrated and described in more detail by the preferred exemplary embodiment, the invention is not limited by the disclosed examples and other variants can be deduced from this by a person skilled in the art without departing from the protective scope of the invention.

### LIST OF REFERENCE SIGNS

1 Furnace vessel
2 Steel-containing material
3 Power supply device
4 Supply system
5 Furnace transformer
6 Electrodes
7 Positioning device
8, 19 Double arrows
9 Control device
10 Control program
11 Machine code
12, 13, 17 Determination blocks
14 Electric arcs
Steel melt
16 Slag layer
18 Trailer block
A1, A2 Activation values
f Frequency
f0 Base frequency
I Electrode currents
L0 Basic length
Residual length LR
P Electric powers
S1 to S21 Steps
T Period
U Electrode voltages
U, I, P Parameters
U*, I*, P* Target values
V Specifications

1. An operating method for an electric arc furnace,
a control device, of the electric arc furnace, initially in a melting phase and after that in a flat-bath phase that follows the melting phase, activating a power supply device of the electric arc furnace using first activation values (A1), so that the power supply device draws electrical energy from a supply system and supplies it via a furnace transformer to electrodes of the electric arc furnace, and furthermore activating a positioning device of the electric arc furnace using second activation values (A2), so that the positioning device positions the electrodes relative to steel-containing material in solid aggregate state, which is located in a furnace vessel of the electric arc furnace, in the melting phase, so that electric arcs form between the electrodes and the steel-containing material in the melting phase, by means of which the steel-containing material is melted to form a steel melt, and is positioned relative to the steel melt in the flat-bath phase, so that in the flat-bath phase electric arcs form between the electrodes and the steel melt, by means of which the steel melt is heated further,
the control device determining both the first activation values (A1) and the second activation values (A2) during the melting phase in such a manner that electrical parameters (U, I, P) of the electrical energy supplied to the electrodes are approximated as far as possible to corresponding target values (U*, I*, P*),
the control device furthermore determining the first activation values (A1) in such a manner during the flat-bath phase that the electrical parameters (U, I, P) are approximated as far as possible to the corresponding target values (U*, I*, P*), but determining the second activation values (A2) either completely independently of the electrical parameters (U, I, P) or depending on the electrical parameters (U, I, P) only if the control device detects the danger of an electric arc breakdown and/or a short circuit on the basis of the electrical parameters (U, I, P).

2. The operating method as claimed in claim 1, wherein that at least during the flat-bath phase, the electrical parameters (U, I, P) are the electrode currents (I).

3. The operating method as claimed in claim 1, wherein AN, at least during the flat-bath phase, the electrical parameters (U, I, P) are the electric powers (P).

4. The operating method as claimed in claim 1, wherein the control device determines the first activation values (A1) during the flat-bath phase in such a manner that to approximate the electrical parameters (U, I, P) to the corresponding target values (U*, I*, P*), a frequency (f) of electrode currents (I) supplied to the electrodes and/or of electrode voltages (U) applied to the electrodes is varied.

5. The operating method as claimed in claim 4, wherein that the frequency (f) of the electrode currents (I) supplied to the electrodes and/or the electrode voltages applied to the electrodes in the flat-bath phase is smaller than a base frequency (f0) of the supply system.

6. The operating method as claimed in claim 1, wherein the electric arcs consequently have a basic length (L0) at the start of the flat-bath phase and in that the control device moves the electrodes toward the steel melt during the flat-bath phase, so that after the moving toward the steel melt, the electric arcs still have a residual length (LR) that is smaller than the basic length (L0).

7. The operating method as claimed in claim 6, wherein that the residual length (LR) is at least 20% of the basic length (L0).

8. The operating method as claimed in claim 6, wherein the control device determines the basic length (L0) on the basis of the electrical parameters (U, I, P) as they are present at the start of the flat-bath phase.

9. A control program product for a control device of an electric arc furnace, comprising a non-transitory medium having recorded thereon a non-transitory control program comprising machine code that can be executed by the control device, the execution of the machine code by the control device causing the control device to operate an electric arc furnace according to the method of claim 1.

10. A control device of an electric arc furnace configured to operate the electric arc furnace according to the method of claim 1.

11. An electric arc furnace,
the electric arc furnace having a furnace vessel, to which steel-containing material can be supplied in solid aggregate state,
the electric arc furnace having a power supply device and electrodes and also a furnace transformer,
the power supply device being connected at the input side to a supply system and at the output side via the furnace transformer to the electrodes,
the electric arc furnace having a positioning device, by means of which the electrodes can be positioned relative to the steel-containing material in a melting phase and relative to a steel melt, which is created by melting the steel-containing material, in a flat-bath phase that follows the melting phase,
the electric arc furnace having a control device, by which, both in the melting phase and in the flat-bath phase, the power supply device can be activated using first activation values (A1) and the positioning device can be activated using second activation values (A2),
the control device as claimed in claim 10.
